(19) United States
(12) Patent Application Publication
(10) Pub. No.: US 2006/0123161 A1
(43) Pub. Date: Jun. 8, 2006

(54) Methods and systems for buffering console port data in a telecommunications equipment shelf assembly

(75) Inventors: Robert L. Wallace, Apex, NC (US); Lixuan Wu, Cary, NC (US); David Knierim, Cary, NC (US)

Correspondence Address: JENKINS, WILSON & TAYLOR, P. A., 3100 TOWER BLVD, SUITE 1200, DURHAM, NC, 27707, US

(73) Assignee: Tekelec

(21) Appl. No.: 11/282,958

(22) Filed: Nov. 18, 2005

Related U.S. Application Data
(60) Provisional application No. 60/629,174, filed on Nov. 18, 2004.

(51) Int. Cl. G06F 5/00

(52) U.S. Cl. 710/52

(57) ABSTRACT

A method and system for retaining serial port data is provided. Under certain conditions, such as following a system reset, the storage of current serial port data is inhibited. A determination is made whether non-volatile storage media is available. If non-volatile storage media is available, then data from the buffer containing previously received serial port data is transferred to the non-volatile storage medium. Once the transfer is complete, the storage in a buffer of current serial port data is enabled. If non-volatile storage media is not available, then buffering remains inhibited.

### RELATED APPLICATIONS

This application claims the benefit of U.S. Provisional Patent Application Ser. No. 60/629,174, filed Nov. 18, 2004, the disclosure of which is incorporated herein by reference in its entirety.

### TECHNICAL FIELD

The subject matter described herein relates to capturing console port data from an unsupervised electronic circuit card. More particularly, the subject matter described herein provides methods and systems for buffering console port data in an application node card in a telecommunications equipment shelf assembly.

### BACKGROUND ART

It is well known to arrange telecommunications equipment in shelf assemblies. In some shelf assemblies, circuit cards are removably connected to a backplane or midplane. The circuit cards may be arranged in parallel to one another and may be guided to be perpendicular to the backplane or midplane. Electrical connections are established between connectors on the backplane or midplane and complementary connectors on the back edge of each circuit card. Typically, the connectors include multiple pins and sockets arranged in one or more rows along part or all of the back edge of the circuit card. When a circuit card is inserted into the equipment shelf, the shelf guides provide an approximate alignment for the pins and sockets, and a precise alignment is achieved by the mating portions of the connectors.

Shelf assemblies permit the deployment of several application cards in a comparatively small space. In many shelf architectures, a shelf management interface card is provided to monitor shelf status and provide the ability to manage cards within the shelf, for example by relaying network management queries and responses between a system manager and an application card. The shelf management interface card may also provide a pathway through which an external management console may interface with an application card in a shelf assembly, such as that described in commonly-assigned, co-pending U.S. Provisional Patent Application Ser. No. 60/626,801, entitled METHODS AND SYSTEMS FOR PROVIDING MANAGEMENT IN A TELECOMMUNICATIONS EQUIPMENT SHELF ASSEMBLY USING A SHARED SERIAL BUS, filed on Nov. 10, 2004, the disclosure of which is incorporated herein by reference in its entirety.

The console port enables a system manager to interact with the application card at a low level, such as at the basic input/output system (BIOS) or operating system levels. The system manager may be able to make changes to the application configuration or initialization information to enable a malfunctioning application card to initialize correctly. In addition, in the event that an application card fails, the operating system may use the console port to output information that may be useful for debugging. If each application card has its own console port, data written from the console port to an external device may be captured for diagnostic purposes. However, in more recent architectures, such as that described in the above-referenced commonly-assigned, co-pending patent application, each application card may not always be connected to a shelf or system-level console port. Accordingly, if a failure occurs when an application card is not connected to the shared console port, the data will be lost. An application card may be deployed as a stand-alone unit (i.e., not part of a shelf) and console port data may be lost if the console port of the stand-alone unit is not being monitored.

Another problem that may exist in preserving console port data is preventing console port data from being over-written before it can be read by an operating system or an external diagnostic device.

Accordingly, there is a need to provide a system and method for buffering console port data from an unsupervised electronic circuit card, thereby enabling console port data to be stored and/or viewed at a later time.

### DISCLOSURE OF THE INVENTION

In accordance with the subject matter described herein, a method for retaining serial port data is provided. Under certain conditions, such as following a system reset, the storage of current serial port data is inhibited. A determination is made whether a non-volatile storage medium is available. If a non-volatile storage medium is available, then data from the buffer containing previously received serial port data is transferred to the non-volatile storage medium. Once the transfer is complete, the storage in a buffer of current serial port data is enabled. If the non-volatile storage medium is not available, then buffering remains inhibited.

In accordance with another aspect of the subject matter described herein, the determination of whether non-volatile storage media is available may be made by attempting to access storage media using an operating system function or attempting to access a predetermined memory address location where non-volatile storage media is expected to be located. The success of the access may be determined by evaluating any error value returned by the operating system function. The success of the access may also be determined by writing data to the predetermined memory address location, reading data from the predetermined memory address location, and comparing the read data to the written data.

### BRIEF DESCRIPTION OF THE DRAWINGS

FIG. 1 is a block diagram of a buffered console port in accordance with one aspect of the subject matter described herein;

FIG. 2 is an block diagram of another embodiment of the buffered console port in accordance with the subject matter described herein;

FIG. 3 is a flow diagram of a method for buffering console port data in accordance with an embodiment of the subject matter described herein;

FIG. 4 is a flow diagram of a method for transferring data from the ring buffer to a non-volatile storage medium in accordance with an embodiment of the subject matter described herein;

FIG. 5 is a system level block diagram of an application card deployed in a stand-alone configuration and connected to a terminal device in accordance with an embodiment of the subject matter described herein; and

FIG. 6 is a system level block diagram of an application card deployed in a shelf assembly and connected to a terminal device via a shared midplane in accordance with an embodiment of the subject matter described herein.

### DETAILED DESCRIPTION OF THE INVENTION

The subject matter described herein provides a system and method for buffering data from an application card console port interface. The application card console port interface provides a control interface for an external system manager. The application card may be a self-contained piece of equipment or may be deployed as a card in a shelf assembly. In a shelf assembly, a shelf management card may provide a relay point between the external system manager and the console port or the console port may be accessed directly through a dedicated serial interface, for example via a rear transition module associated with the application card.

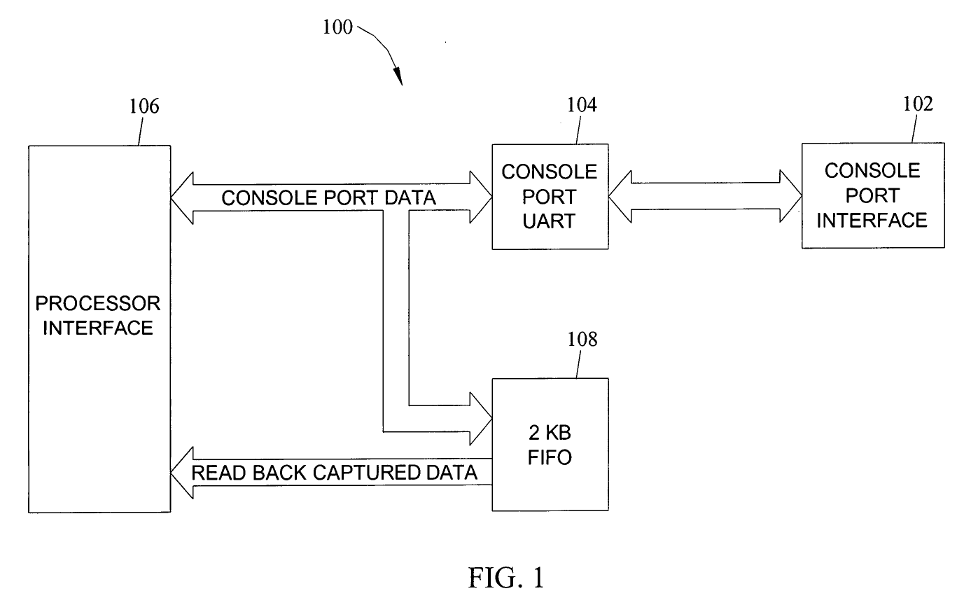

FIG. 1 is a block diagram of a buffered console port 100 in accordance with one aspect of the subject matter described herein. Console port 100 provides access to functions of the application card BIOS and/or operating system and may be used to set initialization parameters. In addition, the application card operating system may use console port 100 to output information as the application card terminates application processes. In the event that the application card terminates a process due to a process error or malfunction, the information output by the application card may be useful in helping to identify the cause of the process error or malfunction.

As shown in FIG. 1, console port interface 102 provides serial data transport through a dedicated serial I/O interface device 104, such as a universal asynchronous receiver-transmitter (UART). As is known to the art, a UART 104 receives data from a processor interface 106 and converts the data into a serial bit stream having a format that is compatible with a device connected to console port interface 102. For example, UART 104 may add start, stop, and parity bits to each character and transmit the character to console port interface 102 at a specified serial data rate. Likewise, serial data that is received at a specified serial data rate from console port interface 102 is converted by UART 104 into a suitable format by removing the start, stop, and parity bits. UART 104 may employ common flow control techniques and an internal data buffer to provide efficient communication between processor interface 106 and console port interface 102.

In accordance with one aspect of the subject matter described herein, data written from processor interface 106 to UART 104 is also stored in console port buffer 108. Console port buffer 108 may be connected in parallel to UART 104, such that data and control signals sent from the processor interface 106 to the UART 104 are received by UART 104 and console port buffer 108. It should be appreciated by one skilled in the art that in order for processor interface 106 to write data to both devices simultaneously, the write-cycle timing of console port buffer 108 should be compatible with the write-cycle timing of UART 104. Any write-acknowledge signal required by processor interface 106 may be generated by UART 104.

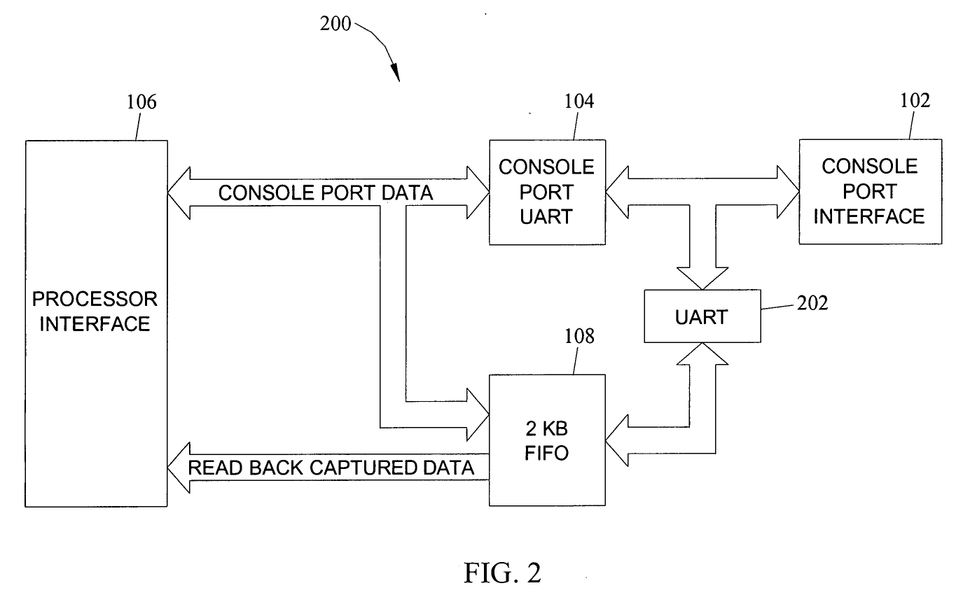

FIG. 2 is an block diagram of another embodiment of a buffered console port 200 in accordance with the subject matter described herein. As in the previous embodiment, console port interface 102 provides serial data transport through console port UART 104. Console port UART 104 receives data from processor interface 106 and converts the data into a serial bit stream having a format that is compatible with a device connected to console port interface 102. In this embodiment, console port UART 104 transmits data to a buffer UART 202 in addition to the console port interface 102. Buffer UART 202 should be configured to receive data at the same rate and format as the device connected to console port interface 102. Buffer UART 202 receives the serial data from console port UART 104, removes any start, stop, and parity bits, and makes the data available to console port buffer 108. Console port buffer 108 may include logic needed to interface with and retrieve data from buffer UART 202. It should be appreciated that the embodiment shown in FIG. 2 provides the ability to buffer serial port data in the event that access to the processor/UART interface is not available.

In either embodiment, console port buffer 108 may be configured as a ring buffer. As is known to the art, a ring buffer may be implemented using an array of contiguous memory locations. A write pointer is used to indicate the address of the next available memory location of the ring buffer, while a read pointer is used to indicate the address of the memory location that contains the oldest data byte in the ring buffer. Once a memory location is written to, the write pointer may be incremented to indicate the location of the next available memory location. If the write pointer and read pointer indicate the same memory location, the last available memory location has been written to and the ring buffer is full. In embodiments of the subject matter described herein, the ring buffer is configured to capture a predetermined amount of data. Once the ring buffer is full, older data may be overwritten to permit the storage of more recent data. Thus, if the write pointer and read pointer indicate the same memory location, the read pointer is incremented to indicate the memory location of the next-oldest data byte and the memory location of the oldest data byte becomes available.

Data received by UART 104 may be written to ring buffer 108 at the memory location indicated by the value of the write pointer. The value of the write pointer may be incremented either before or after data is written to the ring buffer, provided that memory locations of the ring buffer are not unintentionally skipped or overwritten. Thus, a write cycle to the ring buffer memory may include either first incrementing the value of the write pointer and then writing data to the memory location indicated by the write pointer or first writing data to the memory location indicated by the write pointer and then incrementing the value of the write pointer. Each time the write pointer is incremented, the new value of the write pointer may be evaluated to ensure that the write pointer indicates a memory location within the predetermined array of contiguous memory locations. If the value of the write pointer indicates a memory location outside the predetermined array of contiguous memory locations, the value of the write pointer may be set to indicate the first memory location in the array.

Console port buffer 108 includes a buffer enable signal or register. During application card initialization, console port buffering is disabled to prevent data in the buffer from being overwritten, for example, by application process initialization messages. The operating system copies data stored in console port buffer 108 to a more permanent location, such as a storage drive associated with the application card. Processor interface 106 may directly accesses data stored in console port buffer 108. For example, processor interface 106 may perform a series of read operations from a predetermined address associated with the console port buffer and receive data stored in console port buffer 108, beginning with the oldest stored data. The retrieved data may be written to the more permanent storage location. Once the information in console port buffer 108 has been copied, the operating system enables console port buffering. If the operating system is not able to successfully copy the information in console port buffer 108 to another location, the operating system will not enable console port buffering. Rather, information in console port buffer 108 is preserved and may be retrieved by a terminal attached to the console port or another attempt to save the contents of console port buffer 108 may be made.

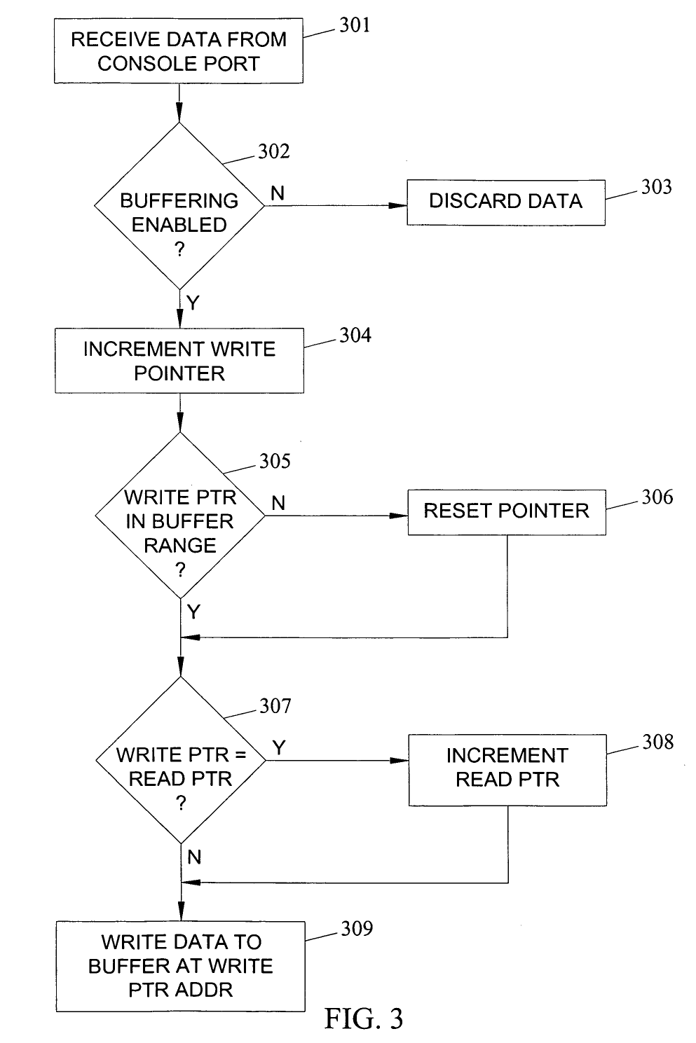

FIG. 3 is a flow diagram of a method for buffering console port data in accordance with an embodiment of the subject matter described herein. In step 301, data is received by console buffer 108. The data may be any suitable data that is written to a console port. For example, the data may be a panic dump from a Linux-based operating system when an application card fails. In step 302, it is determined whether buffering is enabled. Buffering may be enabled after previously-received console port data has been read from the console port buffer. If, in step 302, console port buffering is not enabled, the received data is discarded (step 303). If, however, console port buffering is enabled, the value of the write pointer is incremented (step 304) and evaluated to determine if the value of the write pointer is within the predetermined range of memory addresses allocated for the ring buffer (step 305). If the write pointer is outside the range of memory addresses allocated for the ring buffer, the write pointer is set to the address of the first memory location of the ring buffer (step 306). If, in step 307, it is determined that the write pointer and read pointer indicate the same address, the value of the read pointer is incremented (step 308). As with the write pointer, each time the read pointer is incremented, the value of the read pointer should be evaluated to ensure that the read pointer indicates a memory location within the predetermined range of memory addresses allocated for the ring buffer. In step 309, the received data is written to the ring buffer at the memory location indicated by the write pointer.

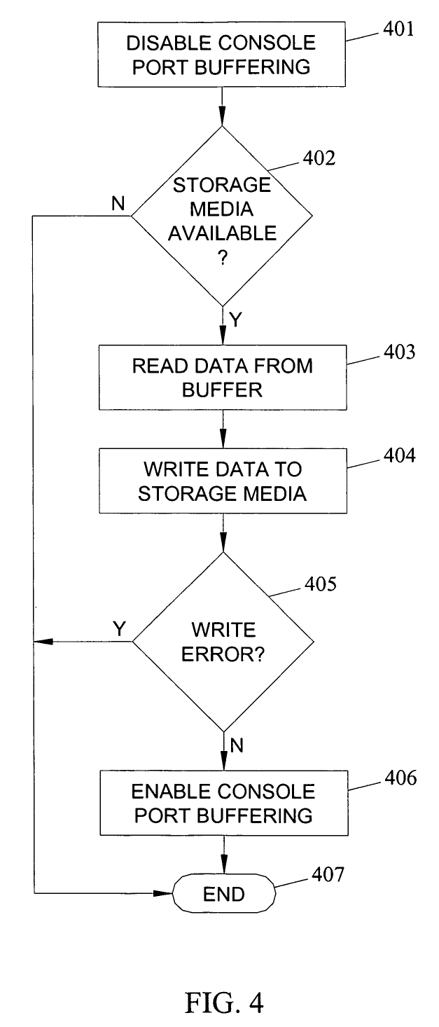

FIG. 4 is a flow diagram of a method for transferring data from the ring buffer to a non-volatile storage medium, such as non-volatile memory or a magnetic storage drive. The method may be initiated after power-up or a system or processor reset. In step 401, console port buffering is disabled to prevent data in the buffer from being overwritten by system initialization messages. In step 402, the processor determines whether a non-volatile storage medium is available, for example, by querying the BIOS or operating system or by attempting to access a predetermined memory address location. If storage media is available, the processor reads data from the buffer (step 403) and writes the data to the storage medium (step 404). The processor may read the buffered data into memory before writing the data to the storage medium or may perform the transfer using several read and write cycles. When the processor attempts to write data to the storage medium, the processor determines whether the write operation was successful (step 405). The determination may be made by checking the returned error state of an operating system function used to perform the write operation or the processor may read back and verify the data just written. Once all of the buffered data is written to the storage medium, the processor enables console port buffering (step 406). However, if storage media is not available (step 402) or if an attempt to write buffered data to the storage medium fails (step 405), the process terminates (step 407) and console port buffering remains disabled.

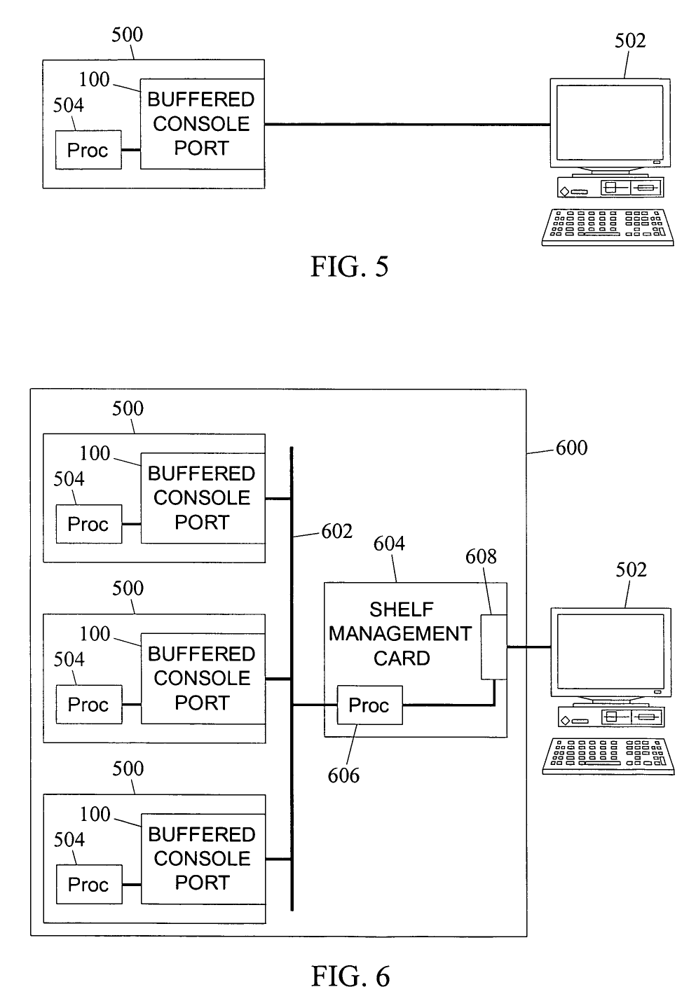

FIG. 5 is a system level block diagram of an application card 500 deployed in a stand-alone configuration and connected to a terminal device 502. Application card 500 may include buffered console port 100 and an application processor 504. Buffered console port 502 may buffer data written by application processor 504 when application card 502 is not connected to terminal device 502. As discussed above with respect to FIGS. 1 and 2, buffered console port 100 includes console port interface 102, which provides serial data transport between a device connected to console port interface 102 and UART 104. As such, in FIG. 5, buffered console port 100 may support a serial interface, such as EIA/TIA-232, compatible with terminal device 502.

FIG. 6 is a system level block diagram of an application card 500 deployed in a shelf assembly 600 and connected to a terminal device 502 via a shared midplane 602, such as that described in greater detail in the commonly assigned, co-pending patent application noted above. Application card 500 may include buffered console port 100. As discussed above with respect to FIGS. 1 and 2, buffered console port 100 includes console port interface 102, which provides serial data transport between a device connected to console port interface 102 and UART 104. As such, in FIG. 6, console port interface 102 may support a serial interface, such as EIA/TIA-422 or EIA/TIA-485, that is compatible with shared midplane 602. A shelf management card 604 may provide selective connectivity between terminal device 502 and each application card 500 via shared midplane 602. For example, shelf management card 604 may include a processor 606 that selectively connects each application card console port 100 to terminal device 502 via system level console port 608. In one exemplary implementation, processor 606 may provide a connection menu for controlling connections between terminal device 502 and console ports 100.

Accordingly, the subject matter described herein provides a method and system for buffering data from a console port, thereby preserving the data for later inspection by a system manager or service technician.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for buffering serial port data comprising:
(a) inhibiting storage of current serial port data in a buffer;
(b) determining whether a non-volatile storage medium is available; and
(c) in response to determining that the non-volatile storage medium is available:
(i) transferring previously-stored serial port data from the buffer to the non-volatile storage medium; and
(ii) enabling storage of current serial port data in the buffer.

2. The method of claim 1 wherein inhibiting storage of current serial port data in a buffer includes:
(a) receiving a reset signal; and
(b) in response to receiving the reset signal, generating a control signal that inhibits the storage of current serial port data in the buffer.

3. The method of claim 1 wherein determining whether a non-volatile storage medium is available includes:
(a) attempting to access a predetermined memory address location in the non-volatile storage medium; and
(b) determining whether the attempt to access the predetermined memory address location was successful.

4. The method of claim 3 wherein determining whether the attempt to access the predetermined memory address location was successful includes:
(a) writing data to the predetermined memory address location;
(b) reading data from the predetermined memory address location; and
(c) verifying that the data read from the predetermined memory address location matches the data written to the predetermined memory address location.

5. The method of claim 1 wherein determining whether a non-volatile storage medium is available includes:
(a) attempting to access a storage medium using an operating system function; and
(b) determining whether an error value returned by the operating system function indicates the attempted access to the storage medium failed.

6. The method of claim 1 wherein transferring data from the buffer to the non-volatile storage medium includes:
(a) determining a value of a read pointer associated with the buffer;
(b) reading data stored at a buffer memory location indicated by the value of the read pointer; and
(c) writing the data to the non-volatile storage medium.

7. The method of claim 1 comprising:
(a) receiving serial port data;
(b) determining whether buffering is enabled;
(c) in response to determining that buffering is not enabled, discarding the data; and
(d) in response to determining that buffering is enabled, storing the data in the buffer.

8. The method of claim 7 wherein storing data in the buffer includes:
(a) incrementing a write pointer;
(b) determining whether the write pointer indicates a memory address within a predetermined range of memory addresses;
(c) in response to determining that the write pointer is not within the predetermined range, setting the write pointer to a predetermined value;
(d) determining whether the write pointer and a read pointer contain the same value;
(e) in response to determining that the write pointer and the read pointer contain the same value, incrementing the read pointer; and
(f) writing the data to the memory address indicated by the write pointer.

9. An application card comprising:
(a) a processor adapted to execute a predetermined set of instructions;
(b) a serial I/O interface device operatively coupled to the processor and adapted to receive data from the processor and format the data into a serial bit stream; and
(c) a data buffer operatively coupled to the serial I/O interface device and adapted to store a predetermined amount of data received by the serial I/O interface device, the data buffer being operatively coupled to the processor and adapted to receive a control signal from the processor and determine whether to store data depending on a state of the control signal, the data buffer further being adapted to provide data stored in the data buffer to the processor.

10. The application card of claim 9 wherein the serial I/O interface device provides a management interface to the application card.

11. The application card of claim 9 wherein the data buffer is configured as a ring buffer thereby permitting older data to be overwritten by newer data once the ring buffer is full.

12. The application card of claim 9 comprising a non-volatile storage medium operatively coupled to the processor, wherein data read from the data buffer by the processor is stored in the non-volatile storage medium.

13. The application card of claim 12 wherein the non-volatile storage medium comprises a magnetic storage unit.

14. A shelf management system comprising:
(a) a first card including a console port adapted to interface with an external management device;
(b) a second card including a serial I/O interface device and an application processor; and
(c) a data buffer operatively coupled to the serial I/O interface device and adapted to store a predetermined amount of data received by the serial I/O interface device, the data buffer being operatively coupled to the application processor and adapted to receive a control signal from the application processor and determine whether to store data depending on a state of the control signal, the data buffer further being adapted to provide data stored in the data buffer to the application processor.

15. The shelf management system of claim 14 wherein the first card comprises a shelf management card and the second card comprises an application card.

16. The shelf management system of claim 14 wherein the first card comprises a first application card and the second card comprises a second application card.

17. The shelf management system of claim 14 comprising a processor coupled to the console port for providing a connection menu for controlling connections between the external management device and the second card.

18. The shelf management system of claim 17 wherein the processor is adapted to receive a connection request from the external management device via the connection and, in response, for connecting the external management device to the data buffer so that the data in the data buffer can be read.

19. The shelf management system of claim 14 comprising at least one third card including a serial I/O interface device and an application processor, the serial I/O interface device being coupled to the shared serial management bus and wherein the console port is adapted to provide selective access to the serial I/O interface devices on the second and third cards via the shared serial management bus.

20. The shelf management system of claim 14 comprising:
(a) a non-volatile storage medium operatively coupled to the application processor, wherein data read from the data buffer by the application processor is stored in the non-volatile storage medium; and
(b) a shared serial management bus adapted to interface with the console port on the first card and the serial I/O interface device on the second card and providing a data transport path therebetween.

21. The shelf management system of claim 20 wherein the shared serial management bus is implemented in a midplane of a shelf assembly.

22. A shelf management system comprising:
(a) a plurality of application cards, each including a processor and buffered console port for buffering console port data written by the processor; and
(b) a shelf management card including a system-level console port for selectively connecting each of the buffered console ports to an external management device for reading the buffered console port data.
